(19) United States
(12) Patent Application Publication
(10) Pub. No.: US 2025/0230787 A1
(43) Pub. Date: Jul. 17, 2025

(54) METHOD FOR DETERMINING A LEAKAGE IN A HIGH-PRESSURE REGION OF A FUEL SUPPLY SYSTEM

(71) Applicant: Robert Bosch GmbH, Stuttgart (DE)

(72) Inventor: Peter Landgraf, Herrenberg (DE)

(21) Appl. No.: 19/010,703

(22) Filed: Jan. 6, 2025

(30) Foreign Application Priority Data
Jan. 15, 2024 (DE) 10 2024 200 322.0

(51) Int. Cl. F02M 65/00; G01M 3/26

(52) U.S. Cl. CPC F02M 65/006; F02M 2200/40; G01M 3/26

(57) ABSTRACT

A method for determining a leakage of fuel in a high-pressure region of a fuel supply system for an internal combustion engine of a vehicle. A curve of a pressure in a high-pressure accumulator of the fuel supply system is provided. A value for a pressure drop is determined in each of one or more segments of the curve, wherein in one segment or in each of the plurality of segments the vehicle is in overrun, no fuel is injected into the internal combustion engine, and no fuel is pumped into the high-pressure accumulator. Information about the leakage is determined on the basis of the one or more values.

### CROSS REFERENCE

The present application claims the benefit under 35 U.S.C. § 119 of German Patent Application No. DE 10 2024 200 322.0 filed on Jan. 15, 2024, which is expressly incorporated herein by reference in its entirety.

### FIELD

The present invention relates to a determination for detecting a leakage of fuel in a high-pressure region of a fuel supply system for an internal combustion engine of a vehicle and to a computing unit and a computer program for carrying out same.

### BACKGROUND INFORMATION

In the case of modern internal combustion engines, fuel is supplied by means of fuel injectors, which receive the fuel from a high-pressure accumulator, also known as a rail or common rail. To pump fuel from a fuel tank into the high-pressure accumulator, high-pressure pumps are used, to which the fuel is fed by means of a low-pressure pump.

### SUMMARY

According to the present invention, a method for determining a leakage and a computing unit and a computer program for carrying out same are provided. Advantageous example embodiments of the present invention are disclosed herein.

The present invention is concerned with the operation of a fuel supply system for an internal combustion engine of a vehicle and, there, in particular with the determination of a leakage in the high-pressure region. Despite, for example, ever-improving manufacturing processes, it is unavoidable that leakages occur in the fuel supply system; escaping or excess fuel is then usually fed into the fuel tank via return lines. In particular in the high-pressure region—there, in turn, especially at the fuel injectors and the high-pressure accumulator—a leakage can lead not only to a loss of fuel but also, in connection with this, to unnecessary pumping of additional fuel, which requires additional energy. In addition, certain functions that rely on the current pressure in the high pressure system may no longer work properly, especially if the leakage is too large. But determining such a leakage has hitherto not been possible, or at least not with sufficient accuracy.

However, the leakage or its specific value can be relevant for various functions such as determining the elastic modulus of the fuel or detecting coking. This is especially true for diesel fuel.

Against this background, providing a curve of the pressure in the high-pressure accumulator of the internal combustion engine is provided; for this purpose, according to an example embodiment of the present invention, the pressure can be sensed or determined by means of a suitable sensor. For this purpose, it is possible to use, for example, a pressure sensor that is usually present, for example on the high-pressure accumulator, which pressure sensor can be read out, for example, by an executing engine control unit. The curve is preferably sensed or determined, for this purpose, according to an angle or crankshaft angle of the internal combustion engine (i.e. in synchronization with the crank angle), especially since possible speed effects then have no impact.

The curve of the pressure is typically regulated to a certain value within the framework of a control system. While fuel is removed from the high-pressure accumulator due to injections by means of the fuel injectors, which reduces the pressure, the high-pressure pump pumps additional fuel back into the high-pressure accumulator, as a result of which the pressure is increased.

According to an example embodiment of the present invention, it is now provided that the pressure or the pressure curve be considered for one or more specific segments of the curve, namely in which the vehicle is in overrun, no fuel is injected into the internal combustion engine, and no fuel is pumped into the high-pressure accumulator. If there are several such segments, for example a relatively long time period with overrun can be selected, in which overrun is then present for the entire curve. There, segments in which no additional fuel is pumped into the high-pressure accumulator are then to be selected accordingly. At this point it should also be mentioned that the curve does not necessarily have to be a continuous or quasi-continuous curve; rather, the relevant segments are sufficient. Nevertheless, in practice there will be a continuous or quasi-continuous curve in which the relevant segments can then be selected or determined accordingly.

A value for a pressure drop is then determined in each of these segments; for this purpose, for example a value of the pressure at the beginning and at the end of the segment can be determined, from which the difference is then determined. This can also be done with averages. The pressure drop in such segments has been shown to be an indicator of the leakage, because other deliberate pressure changes do not occur.

On the basis of the one or more values, information about the leakage is then determined, the information about the leakage preferably comprising information about a level of the leakage.

In one embodiment, a reference value for a leakage of a reference fuel supply system can be provided for this purpose, the level of the leakage then being determined on the basis of the one or more values and the reference value. The reference value can be obtained, for example, from a corresponding characteristic map in which comparison values are provided for different conditions such as pressures in the high-pressure accumulator, temperatures and the like. This allows a quotient of current leakage and nominal leakage to be determined.

It is useful if a value for a pressure drop is determined in each of a plurality of segments of the curve, i.e., if a plurality of measured values are available. The number of segments or values can be, for example, more than ten or more than 20 or even more than 50. On the basis of the plurality of values, the information about the leakage is then determined using a filter and/or averaging. In this way, a more accurate value can be obtained.

In one example embodiment of the present invention, the curve of the pressure is sensed at a frequency of at least 1 kHz, preferably at least 5 kHz, more preferably at least 10 kHz. Such high sampling frequencies allow particularly accurate values to be obtained.

In one example embodiment of the present invention, the curve of the pressure is sensed at an at least average pressure of at least 1500 bar, preferably at least 2000 bar, more preferably at least 2300 bar, in the high-pressure accumulator. In particular, the pressure can be increased to a maximum possible pressure for the desired measurements. Precisely here do the advantages of overrun become apparent, because here the pressure can be easily increased accordingly, whereas increasing the pressure during, for example, idling is generally not desired or even permitted due to the noise it would cause. Since the vehicle is driving in overrun, and usually at a fairly high speed, any noise is hardly disturbing or not at all disturbing.

In one example embodiment of the present invention, a diagnosis is initiated or carried out on the basis of the information about the leakage. In this way it can also be checked, for example, whether the leakage is larger than usual or expected. It is also possible that an error message is issued in such cases, e.g. if a critical threshold for the leakage is exceeded. Such an error message can, for example, comprise a display and/or an acoustic signal for a driver of the vehicle. However, it can also comprise, for example, an error log entry, which then also describes, for example, exactly how severe the pressure drop or the leakage was and when it occurred. This facilitates, for example, later troubleshooting and fault correction.

A computing unit according to the present invention, e.g. a control unit, in particular an engine control unit, of a motor vehicle, is configured, in particular in terms of program, to carry out a method according to the present invention.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. Suitable data carriers for providing the computer program are, in particular, magnetic, optical, and electric storage media, such as hard disks, flash memory, EEPROMs, DVDs, and others. It is also possible to download a program via computer networks (Internet, intranet, etc.).

Further advantages and embodiments of the present invention can be found in the disclosure herein.

The present invention is illustrated schematically in the figures on the basis of an example embodiment and is described below with reference to the figures.

### BRIEF DESCRIPTION OF THE DRAWINGS

FIG. 1 schematically shows a fuel supply system for an internal combustion engine, in which fuel supply system the present invention can be used.

FIG. 2A, 2B show a curve of a pressure in a high-pressure accumulator to explain the present invention.

FIG. 3 shows a sequence of a method according to the present invention in one example embodiment.

### DETAILED DESCRIPTION OF EXAMPLE EMBODIMENTS

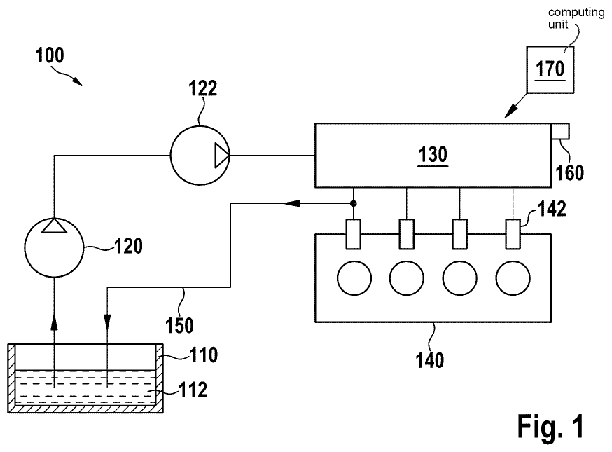

FIG. 1 schematically shows a fuel supply system 100 for a vehicle, comprising an electronic fuel pump 120, a high-pressure pump 122 and an internal combustion engine 140, in which fuel supply system the present invention can be used, as will be briefly explained below. In particular, a fuel tank 110 is provided here, from which fuel 112 can be removed by means of the fuel pump 120 (also pre-supply pump or low-pressure pump) and fed to the high-pressure pump 122. By means of the high-pressure pump 122, the fuel is then pumped into a high-pressure accumulator 130 (a so-called rail), from where the fuel can be removed by means of fuel injectors 142 and introduced into combustion chambers of the internal combustion engine 140. A computing unit 170 in the form of an engine control unit is provided and configured for this purpose, which computing unit can control the fuel injectors 142 in the desired manner.

The engine control unit 170 is also provided and configured, for example, for controlling the electronic fuel pump 120 and, if applicable, the high-pressure pump 122 or an associated metering unit so that fuel can be removed from the fuel tank and, for example, a desired amount of fuel can be pumped into the high-pressure accumulator 130 or a certain pressure can be regulated there. In addition, a pressure sensor 160 is provided, by means of which a pressure in the high-pressure accumulator 130 can be measured or sensed and which can be read out, for example, by the engine control unit 170.

Furthermore, a return 150 (or a return line) from one of the fuel injectors 142 into the fuel tank 110 is shown by way of example. A (further) return line can also be provided for each fuel injector as well as for the high-pressure accumulator 130. Any fuel that escapes from the high-pressure accumulator 130 or one of the fuel injectors 142 due to a leakage can thus be returned to the fuel tank 110. As mentioned above, the present invention now proposes a possibility for detecting or determining such a leakage.

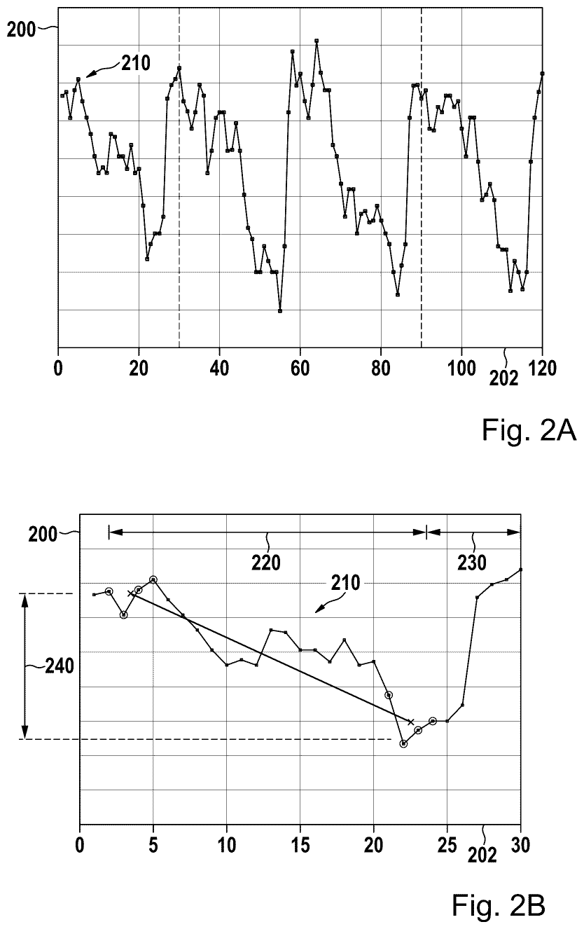

In this regard, in FIG. 2A a curve 210 of a pressure in a high-pressure accumulator is plotted to explain the present invention. The pressure 200 is plotted against an angle 202 in 6-degree steps (e.g. crankshaft angle). The specific values of the pressure are of little relevance for the purposes of the explanation, but can be in the range of 2000 bar, for example. While FIG. 2Aa shows the curve over an angle of 720 degrees (120 times 6 degrees), FIG. 2B shows the segment between 0 and 180 degrees (30 times 6 degrees) according to FIG. 2A.

The curve 210 shown in FIG. 2A can be sensed, for example, by means of the pressure sensor 160 according to FIG. 1.

In FIG. 2B, a segment 220 is now specifically shown in which the vehicle is in overrun, no fuel is injected into the internal combustion engine, and no fuel is pumped into the high-pressure accumulator. In segment 230, on the other hand, fuel is, for example, pumped into the high-pressure accumulator. As can be seen in FIG. 2A, the curve 210 comprises a plurality of the segments 220.

On the basis of the curve in such segments 220, a pressure drop 240 or a value therefor can now be determined. In the example in FIG. 2B, the value of the pressure drop 240 can be, for example, approximately 5 bar. On the basis thereof, information about the leakage can then be determined, as explained below.

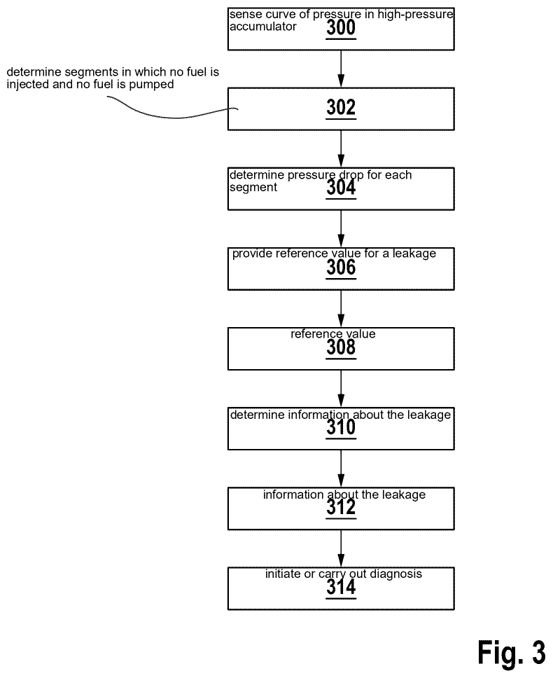

FIG. 3 schematically shows a sequence of a method according to the present invention in one embodiment, which method can be used, for example, in the fuel supply system shown in FIG. 1. For this purpose, a curve of the pressure in the high-pressure accumulator is sensed, e.g. continuously or repeatedly during overrun, in step 300, as shown e.g. in FIG. 2A, this curve then also being provided.

In a step 302, in this curve V, the segments are determined in which no fuel is injected into the internal combustion engine and no fuel is pumped into the high-pressure accumulator, that is to say, for example, segments such as segment 220 according to FIG. 2B.

In a step 304, a value of the pressure drop is then determined for each of these segments, as shown e.g. in FIG. 2B. In step 306, a reference value 308 for a leakage of a reference fuel supply system can be provided. For example, this may include that a reference value of 4 bar corresponds to a certain leakage amount.

In particular also according to the current (average) pressure for the sensed curve and/or the temperature of the fuel can be taken into account here; accordingly, for example a reference value corresponding to the (average) pressure and to the temperature can be drawn from a characteristic map for the reference fuel supply system.

Then, in step 310, information 312 about the leakage is determined and in particular also provided. Accordingly, for a current value of e.g. 5 bar, it can then be calculated or determined that the current leakage amount—in a comparable fuel supply system—is approx. 25% more than in the reference fuel supply system. In a step 314, e.g. a diagnosis can then also be initiated or carried out if necessary.

What is claimed is:

1. A method for determining a leakage of fuel in a high-pressure region of a fuel supply system for an internal combustion engine of a vehicle, the method comprising:
providing a curve of a pressure in a high-pressure accumulator of the fuel supply system;
determining a value for a pressure drop in each of one or more segments of the curve, wherein in one or in each of the plurality of segments, the vehicle is in overrun, no fuel is injected into the internal combustion engine, and no fuel is pumped into the high-pressure accumulator; and
determining information about the leakage is based on the one or more values.

2. The method according to claim 1, wherein the information about the leakage includes information about a level of the leakage.

3. The method according to claim 2, wherein a reference value for a leakage of a reference fuel supply system is provided, and the level of the leakage is determined based on the one or more values and the reference value.

4. The method according to claim 1, wherein the curve of the pressure is sensed at a frequency of at least 1 kHz.

5. The method according to claim 1, wherein the curve of the pressure is sensed at an at least average pressure of at least 1500 bar in the high-pressure accumulator.

6. The method according to claim 1, wherein the value for a pressure drop is determined in each of the plurality of segments of the curve, and based on the plurality of values, the information about the leakage is determined using a filter and/or averaging.

7. The method according to claim 1, wherein a diagnosis is initiated or carried out based on the information about the leakage.

8. A computing unit configured to determine a leakage of fuel in a high-pressure region of a fuel supply system for an internal combustion engine of a vehicle, the computing unit configured to:
provide a curve of a pressure in a high-pressure accumulator of the fuel supply system;
determine a value for a pressure drop in each of one or more segments of the curve, wherein in one or in each of the plurality of segments, the vehicle is in overrun, no fuel is injected into the internal combustion engine, and no fuel is pumped into the high-pressure accumulator; and
determine information about the leakage is based on the one or more values.

9. A non-transitory machine-readable storage medium on which is stored a computer program for determining a leakage of fuel in a high-pressure region of a fuel supply system for an internal combustion engine of a vehicle, the computer program, when executed by a computing unit, causing the computing unit to perform the following steps:
providing a curve of a pressure in a high-pressure accumulator of the fuel supply system;
determining a value for a pressure drop in each of one or more segments of the curve, wherein in one or in each of the plurality of segments, the vehicle is in overrun, no fuel is injected into the internal combustion engine, and no fuel is pumped into the high-pressure accumulator; and
determining information about the leakage is based on the one or more values.
